(19) United States
(12) Patent Application Publication
(10) Pub. No.: US 2009/0067637 A1
(43) Pub. Date: Mar. 12, 2009

(54) Echo control retrofit

(76) Inventors: Lawrence Gollbach, Ben Lomond, CA (US); Steven F. Burson, Scotts Valley, CA (US)

Correspondence Address: PLANTRONICS, INC.;IP Department/Legal, 345 ENCINAL STREET, P.O. BOX 635, SANTA CRUZ, CA, 95060-0635, US

(21) Appl. No.: 10/455,599

(22) Filed: Jun. 4, 2003

(51) Int. Cl. H04B 3/20

(52) U.S. Cl. 381/66

(57) ABSTRACT

The present invention provides an echo control retrofit apparatus and method that advantageously reduces echo when communicating over packet-switched networks. An echo control retrofit apparatus, including an echo control circuit, is operably coupled between a headset or handset device and an audio source. The echo control circuit receives a sound signal from the audio source and a transmit signal from the headset or handset device and provides an adjusted sound signal to the audio source. Advantageously, a variety of existing headsets and handsets may be used in accordance with the present invention to provide reduced caller echo without the need to purchase new headsets or handsets.

### RELATED APPLICATIONS

This application is related to commonly assigned U.S. patent application Ser. No. 10/256,450, filed Sep. 27, 2002, titled “Echo Reduction for a Headset or Handset.”

### BACKGROUND OF THE INVENTION

1. Field of the Invention

This invention generally relates to an apparatus, system, and method for improved telephony and, more particularly, to an apparatus, system, and method for reducing or eliminating echo when communicating over packet-switched telephone connections.

2. Description of Related Art

Digital circuit switches have traditionally been used to route voice traffic and low-throughput data traffic but advances in electronics have made packet-switched digital connections, such as Voice over Internet Protocol (VoIP), increasingly cost-effective.

Circuit switches traditionally provided a physical, dedicated path, called a time slot, for a call when it went through the switching matrix. Because this path was dedicated to the call, no other callers could use the selected switch path until the call ended. This concept of a dedicated path guaranteed high-quality, almost error-free transmission for the call.

Packet switches, in contrast, do not use dedicated paths, but evolved in the 1970s to handle the variable bit rates of data transmission bursts. Packet switches take a user's data stream, break it down into smaller segments, called packets, add network control information, and then transmit the packets through the network in bursts. When a burst of data comes in, switching resources are assigned for that burst, with the resources being shared on an as-needed, first-come, first-served basis. At the end of the burst of data, the resources are available for the next burst of data.

The steady rise in signal processing power, memory capacity, operating speed, and error correction has allowed packet-switched networks to handle the real-time demands of voice traffic. With the huge increase of Internet users and data transmissions over communication networks in the past several years, telecommunication companies and Internet providers are moving to route both voice and data traffic, as well as Internet traffic, over packet-switched networks.

A disadvantage of packet-switched networks has been that the amount of real-time processing required to control the packets has been enormous. Accordingly, the real-time processing has introduced a certain amount of delay in moving a packet through the network. Thus, packet-switched connections necessarily add a perceptible amount of delay to signal transmission, while traditional circuit-switched connections do not create perceptible delay since a path remains fixed once a call is set up. This delay makes objectionable even a small amount of coupling of the received voice signal into the transmitted signal, which causes a caller to hear an echo of his/her own voice. Most callers find such an echo, even one that is not loud, to be distracting and annoying.

Telephone headsets commonly couple more of the received signal into the transmitted signal than is optimal for modern, packet-switched connections. Similarly, many handsets in use today were not designed with the requirements of packet-switched telephony in mind, and therefore couple more of the received signal into the transmitted signal than is optimal.

Therefore, there is a need for an apparatus and method that allows for control of echo related to packet-switched networks when using conventional existing headsets and/or handsets that do not include built-in echo control circuitry.

### SUMMARY

The present invention provides an apparatus and method to easily retrofit echo control circuitry between a headset or handset device and an audio source to advantageously reduce or suppress caller echo associated with packet-switched networks.

In one embodiment of the present invention, an echo control retrofit apparatus is provided, including a first connector half disposed at an end of a first cable. The first connector half includes a housing having a mating end and an oppositely disposed cable receiving end, and an echo control circuit operably coupled to the first cable. A second connector half is disposed at an end of a second cable and also includes a housing having a mating end and an oppositely disposed cable receiving end. The mating ends of the first connector half and the second connector half are capable of being coupled together for operably coupling the second cable to the echo control circuit of the first connector half. The echo control circuit is capable of receiving a sound signal along the first or second cable, comparing the sound signal along the first or second cable to a transmission sound signal received along the other of the first or second cable, and providing an adjusted transmission sound signal to control for echo.

In another embodiment of the present invention, another echo control retrofit apparatus is provided, including a housing enclosing an echo control circuit. A first mating end is coupled to one end of the housing and operably coupled to the echo control circuit, and a second mating end is coupled to another end of the housing and operably coupled to the echo control circuit. The echo control circuit is capable of receiving a sound signal through the first or the second mating end, comparing the sound signal received through the first or the second mating end to a transmission sound signal received through the other of the first or second mating end, and providing an adjusted transmission sound signal to control for echo.

In yet another embodiment of the present invention, a method of retrofitting echo control is provided, including providing an echo control retrofit apparatus capable of operably coupling a first cable and a second cable. The method further includes operably coupling the mating ends of the first connector half and the second connector half, and providing a sound signal from an audio source to the echo control circuit along the first or second cable. Also included in the method is comparing the sound signal from the audio source to a transmission sound signal from a headset or handset device received along the other of the first or second cable, adjusting the transmission sound signal from the headset or handset device as necessary to control for echo, and providing the adjusted transmission sound signal to the audio source.

Advantageously, the present invention allows for simple and economic control of echo when using existing headsets and/or handsets that do not meet the stringent receive-transmit coupling requirements of packet-switched telephony.

These and other features and advantages of the present invention will be more readily apparent from the detailed description of the embodiments set forth below taken in conjunction with the accompanying drawings.

### BRIEF DESCRIPTION OF THE DRAWINGS

FIG. 1 shows a block diagram of an echo control system in accordance with an embodiment of the present invention.

FIG. 2 shows a block diagram of an echo control system as applied in an example of an end-to-end communication system, in accordance with another embodiment of the present invention.

FIG. 3 shows a block diagram of one example of an echo control retrofit apparatus in accordance with an embodiment of the present invention.

FIG. 4A shows a perspective assembly view of an example of a connector half in accordance with an embodiment of the present invention.

FIG. 4B shows a simplified top view of the assembled connector half of FIG. 4A without a main body housing.

FIG. 5 shows a block diagram of another example of an echo control retrofit apparatus in accordance with an embodiment of the present invention.

FIG. 6A shows a perspective assembly view of another echo control retrofit apparatus in accordance with an embodiment of the present invention.

FIG. 6B shows a simplified top view of the assembled echo control retrofit apparatus of FIG. 6A.

FIG. 7A shows one example of an echo control circuit including a DSP in accordance with an embodiment of the present invention.

FIG. 7B shows an example of an analog echo control circuit in accordance with an embodiment of the present invention.

Use of the same or similar reference symbols in different figures indicates identical or similar items.

### DETAILED DESCRIPTION

The present invention provides an echo control retrofit apparatus and method, including echo suppression or cancellation circuitry operably connected between a headset or handset device and an audio source, to advantageously control caller echo that would otherwise occur through a packet-switched network (e.g., the Internet).

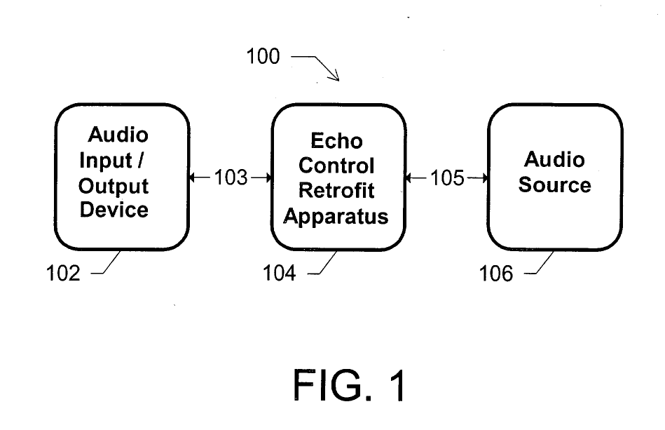

FIG. 1 shows a simplified block diagram of an echo control system 100 in accordance with one embodiment of the present invention. In this embodiment, an echo control retrofit apparatus 104 is operably connected between an audio source 106 and an audio input/output device 102. Echo control retrofit apparatus 104 receives an input audio signal along lead 105 from audio source 106.

The present invention is not limited to a specific audio source 106 and encompasses receiving an audio signal from any applicable audio signal source, for example, a communications network, a computer, a telephone, a cellular telephone, or any other host telephony apparatus. As an example, with no intent to limit the invention thereby, a communications network may include a public switched telephone network (PSTN), an integrated services digital network (ISDN), a local area network (LAN), and/or a wireless local area network (WLAN), with standards such as Ethernet, wireless fidelity (WiFi), and/or voice over internet protocol (VOIP).

Audio input/output device 102 is operably connected to echo control retrofit apparatus 104 via lead 103. Audio input/output device 102 includes speaker (or earphone) and microphone transducers and is capable of sending a sound signal to echo control retrofit apparatus 104 along lead 103. It is noted that in one embodiment, a plurality of echo control retrofit apparatus 104 may be used in parallel to match any number of earphones and associated leakage paths. In another embodiment, a plurality of echo control retrofit apparatus 104 may be used in series to provide increased flexibility in echo control and in coupling audio source 106 and audio input/output device 102.

Echo control retrofit apparatus 104 includes echo suppression and/or cancellation circuitry that is capable of receiving signals from audio source 106 and from audio input/output device 102, comparing the received signals, and providing an adjusted signal to audio source 106 in order to reduce or cancel echo.

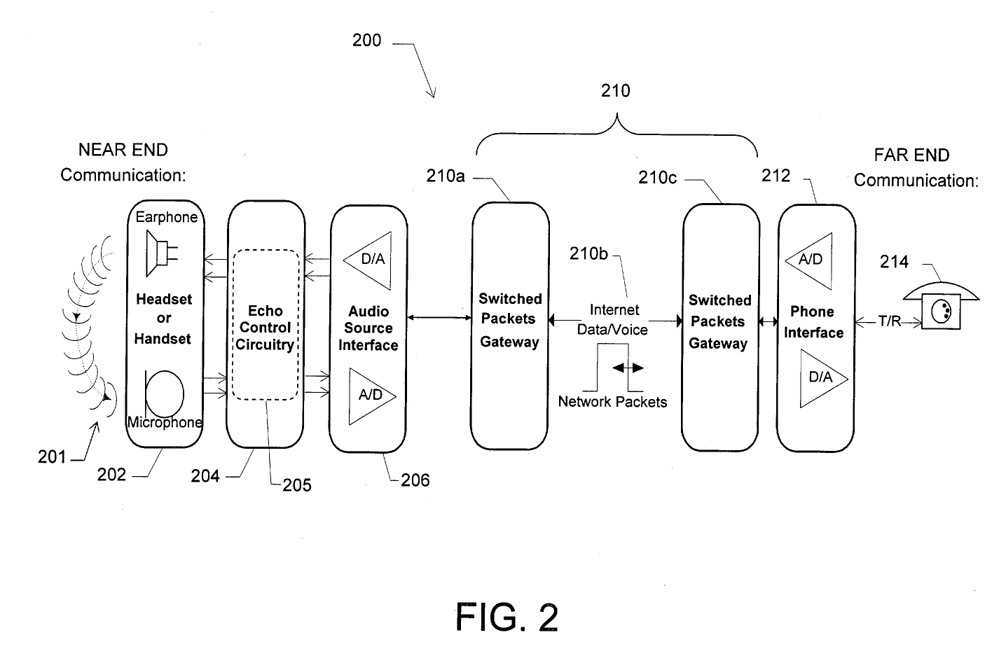

FIG. 2 shows a detailed block diagram of an echo control system 200 in an example of a complete end-to-end telecommunication application, in accordance with another embodiment of the present invention. An echo control retrofit apparatus 204 is operably connected between an audio input/output device and an audio source.

An exemplary embodiment of an audio input/output device is a headset or handset device 202 that includes an earphone transducer and a microphone transducer. Headset or handset device 202 converts the received audio signal from an audio source to an acoustic signal to be heard by the headset or handset device user. Any signal leakage, either internal or external to headset or handset device 202, is represented by leakage path 201. Leakage path 201 represents earphone activity (acoustic and/or electromechanical) that is undesirably coupled to the microphone and transmitted from headset or handset device 202. It is noted that the user's face, ears, and/or mouth can interact with headset or handset device 202 to modify the magnitude and frequency response of the unwanted leakage signal, whether purely acoustic, electromechanical, or a combination of both.

As noted above, several different versions of headset or handset device 202 may be used in conjunction with echo control retrofit apparatus 204 to give the user a choice of headset or handset device to wear or use. Headset or handset device 202 can include any adaptable headset apparatus such as the Encore™ series commercially available from Plantronics®, Inc., located in Santa Cruz, Calif.

As further illustrated in FIG. 2, in accordance with one embodiment of the present invention, headset or handset device 202 is operably connected to an echo control circuit 205 of echo control retrofit apparatus 204. Echo control circuit 205 is further operably connected to an audio source, such as a host telephony system. Typically, leads 103 and 105 (FIG. 1) connecting echo control retrofit apparatus 104 (FIG. 1) are analog in nature and require four wires on each side of the echo control retrofit apparatus: two wires for the receive signal paths and two wires for the transmit signal paths. FIG. 2 illustrates the wires connecting echo control retrofit apparatus 204 between headset or handset device 202 and audio source interface 206 by the eight arrows associated with echo control retrofit apparatus 204.

In this example, the audio source is comprised of an audio source interface 206, such as a telephone or communication terminal, a packet-switched network 210 including gateways 210a and 210c and pathway 210b, a phone interface 212, and a telephone 214. Many other combinations of telephone technology may be involved at either end of the telecommunication link shown in FIG. 2, but common elements will involve packet-switched network 210, which are the gateways and pathways that join digital and/or analog (e.g., PSTN) telephone systems together.

Accordingly, the far end user of telephone 214 can experience an echo of his/her own voice delayed in time, the severity of which is dictated by the acoustic and mechanical isolation limitations of headset or handset device 202 (i.e., the signal leakage path 201), overall network signal gain, and the total amount of fixed and/or varying packet switching delay through network 210. Advantageously, echo control retrofit apparatus 204 reduces this echo by retrofitting echo control circuitry between headset or handset device 202 and the audio source, as described in greater detail below.

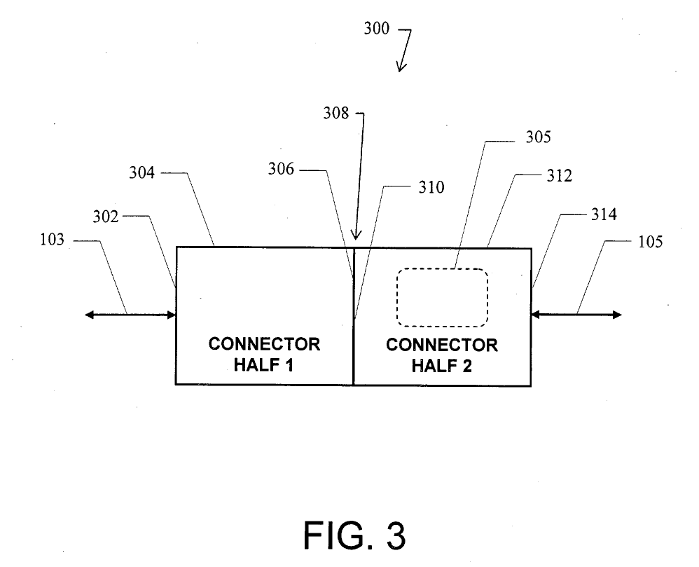

In one embodiment, as shown in FIG. 3, an echo control retrofit apparatus 300 is able to retrofit an echo control circuit 305 between an existing audio input/output device and an existing audio source by enabling modular and operable compatibility of echo control circuit 305 between a first cable 103 that is connected to the audio input/output device and a second cable 105 that is connected to the audio source.

Echo control retrofit apparatus 300 includes a connector half 304 disposed at an end of a cable 103. Connector half 304 includes a mating end 306 and an oppositely disposed cable receiving end 302. Echo control retrofit apparatus 300 further includes a connector half 312 disposed at an end of a cable 105. Connector half 312 also includes a mating end 310 and an oppositely disposed cable receiving end 314. Echo control circuit 305 is operably coupled to an end of cable 105. Mating end 306 of connector half 304 and mating end 310 of connector half 312 are capable of being coupled together along interface 308 for operably coupling cable 103 to echo control circuit 305 of connector half 312.

It should be apparent to those of ordinary skill in the art that the mirror image of echo control retrofit apparatus 300 is within the scope of the present invention. Echo control circuit 305 may be placed within connector half 304 or cable 103 may be connected to the audio source while cable 105 may be connected to the audio input/output device.

An example of a connector housing that may be used in accordance with the present invention, with no intent to limit the invention thereby, is the separable connector for electrically coupling two portions of multiple-conductor cable, described in U.S. Pat. No. 5,259,780, issued on Nov. 9, 1993, to Morrissey, III et al. for “Quick Disconnect Wiring Connector,” which is commonly assigned and incorporated herein by reference for all purposes.

Morrissey, III et al. describe two connector halves that each include therein a plurality of metallic contact strips, such that any two connector halves may be coupled together. Connection of the connector halves is accomplished by pushing the two halves together and disconnection is accomplished by pulling them apart. When connected, continuous electrical contact is maintained between contact strips in each respective half. The connector is constructed of molded plastic, and includes rubber strain relief collars for preventing fatigue and failure of the attached portions of multiple conductor cable.

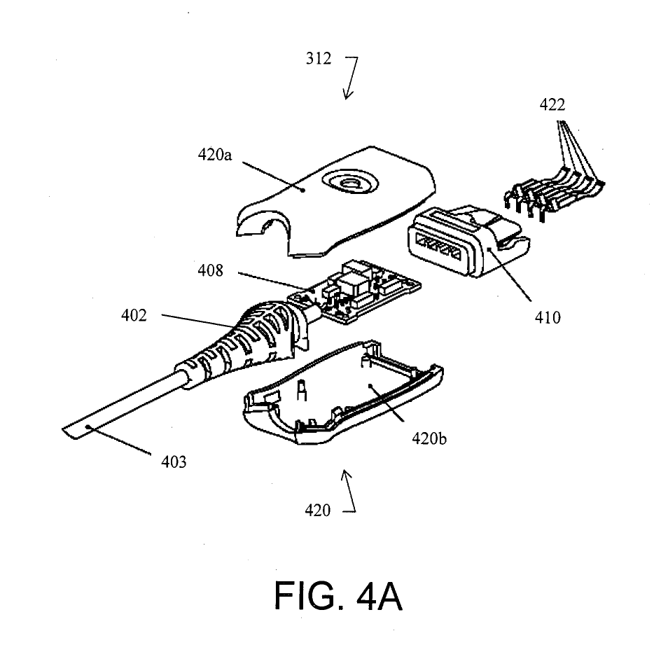

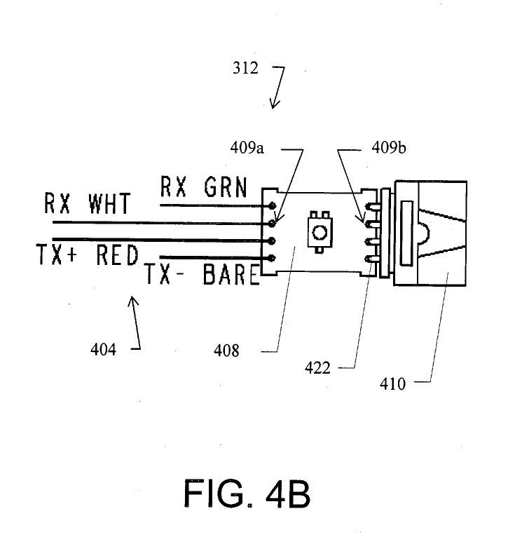

FIG. 4A illustrates an assembly view of connector half 312 in which a similar connector housing as described in Morrissey, III et al. is utilized to allow for retrofitting echo control circuitry between an audio input/output device and an audio source. Echo control circuitry is included in printed circuit board (PCB) 408, which is operably housed within a housing 420, in this example including an upper hood 420a and a lower hood 420b. PCB 408 is operably coupled to contact strips 422 located within mating end 410. PCB 408 is also operably coupled to conductors housed within cable 403, which is received in this example via a rubber strain relief collar 402.

FIG. 4B illustrates a simplified top view of the assembled connector half 312 of FIG. 4A without housing 420 and relief collar 402. FIG. 4B includes an example of a schematic of the conductors 404 housed within cable 403 (FIG. 4A). As noted above, in one example, four conductors (or four wires: two wires for the receive signal paths and two wires for the transmit signal paths) are connected to PCB 408 via contacts 409a in accordance with one embodiment of the present invention. Likewise, connector half 312 may also include four contact strips 422 that connect to PCB 408 via contacts 409b. Accordingly, conductors 404 within cable 403 (FIG. 4A) and contact strips 422 are operably coupled to PCB 408.

A second connector half (e.g., connector half 304 in FIG. 3) may then be used to couple a second set of conductors to the echo control circuitry. A second connector half may be identical or similar to connector half 312. The second connector half includes a similar mating end with contact strips and receives the end of a second multiple-conductor cable. In one example, when the mating ends of the connector halves are pushed together, curved portions of the surrounding plastic on the two halves interlock with one another. When fastened together in this manner, metallic contact strips disposed within one of the connector halves are received into contact with corresponding metallic contact strips similarly disposed within the other connector half, thereby establishing electrical contact between the echo control circuitry of PCB 408 and the conductors in the respective portions of cable (e.g., cables 103, 105 shown in FIG. 3).

It is noted that the mating ends of the connector halves may or may not be gender neutral. Furthermore, the second connector half may optionally include echo control circuitry such that a combination of echo control circuitry within both the first and second connector halves may be utilized for greater flexibility and economy of space in controlling audio echo.

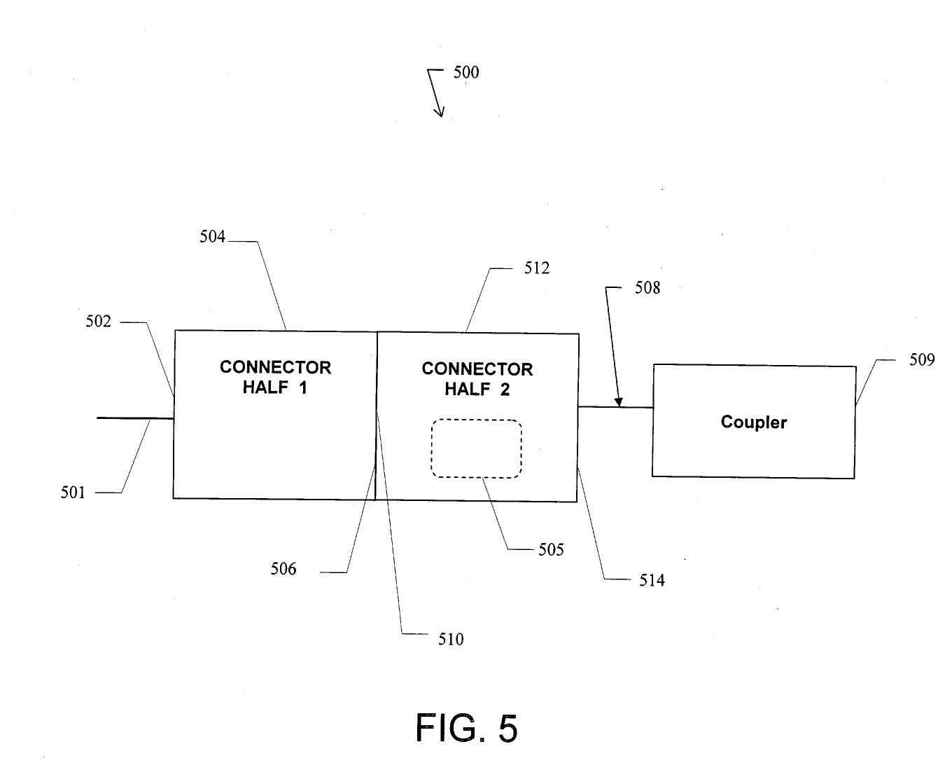

In another embodiment, as shown in FIG. 5, an echo control retrofit apparatus 500 includes a connector half 504 coupled to a connector half 512 which is connected to a coupler 509 via cable 508. Connector half 504 and connector half 512 are substantially similar to connector halves 304 and 312 described above with regard to FIG. 3 and echo control circuit 505 is housed within connector half 512. Connector half 504 includes a mating end 506 and an oppositely disposed cable receiving end 502 receiving a cable 501. Connector half 512 includes a mating end 510 and an oppositely disposed cable receiving end 514 receiving a cable 508. Echo control circuit 505 is operably coupled to conductors within cable 508 and is thus operably coupled to coupler 509.

Coupler 509 includes for example, an amplifier, a RJ-11 connector, and a 2.5 mm or 3.5 mm plug. An example of an amplifier suitable for use in the present invention, with no intent to limit the invention thereby, is a Vista™ Universal Amplifier Model M12, available from Plantronics®, Inc., located in Santa Cruz, Calif. The above described examples are not meant to be limiting and it is noted that coupler 509 is generally any coupling device that may be used for eventual coupling of connector half 512 to an audio source or audio input/output device.

Advantageously, echo control retrofit apparatus 500 may be utilized to provide flexibility in retrofitting echo control circuit 505 between an audio source and an audio input/output device. For example, coupler 509 may operably connect to an audio source (e.g., a telephone) via an amplifier or a RJ-11 connector while connector half 504 connects to an audio input/output device (e.g., a headset or handset) via cable 501. In another example, coupler 509 may operably connect to an audio input/output device (e.g., a headset or handset) via a 2.5 mm or 3.5 mm plug while connector half 504 connects to an audio source (e.g., a telephone) via cable 501.

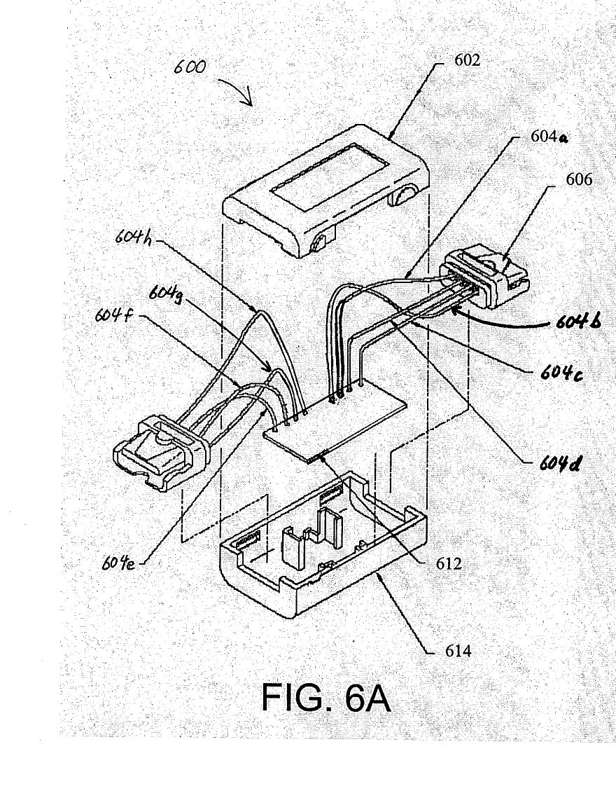

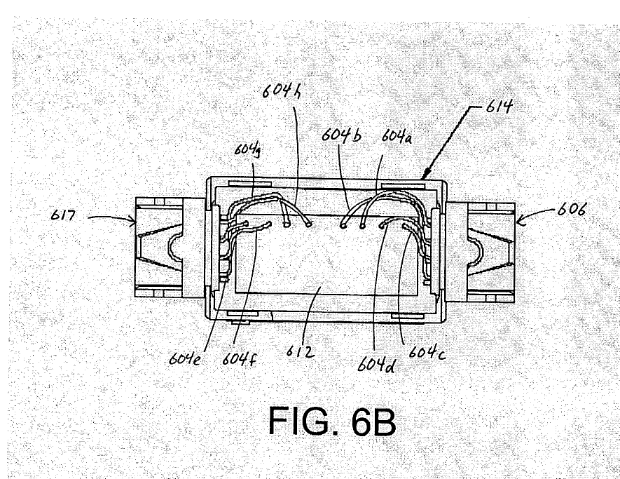

FIGS. 6A and 6B illustrate an assembly view and a simplified top view, respectively, of another echo control retrofit apparatus 600 for retrofitting echo control circuitry between an audio input/output device and an audio source. In this embodiment, echo control circuitry is included in printed circuit board (PCB) 612, which is operably housed within a housing including an upper hood 602 and a lower hood 614. In one example, PCB 612 is operably coupled to conductors 604a through 604h as shown in FIG. 6A. The ends of these conductors are operably coupled to contact strips (not shown) located within mating ends 606 and 617, which are substantially similar to the mating ends described above with regard to FIGS. 4A and 4B. It should be understood that other configurations of conductors may be coupled to PCB 612 in order to allow the echo control circuitry of PCB 612 to function properly.

FIG. 6B illustrates a simplified top view of the assembled echo control retrofit apparatus 600 without a top hood of the housing. Echo control retrofit apparatus 600 can then be used as a modular assembly to retrofit echo control circuitry between existing structures with mating ends that are compatible with mating ends 606, 617 of echo control retrofit apparatus 600.

It should be understood that various combinations of echo control retrofit apparatus 300 and/or echo control retrofit apparatus 500 and/or echo control retrofit apparatus 600 may be used with one another or a plurality of one another to provide flexibility in retrofitting echo control circuitry and combinations of echo control circuitry between the audio source and the audio input/output device.

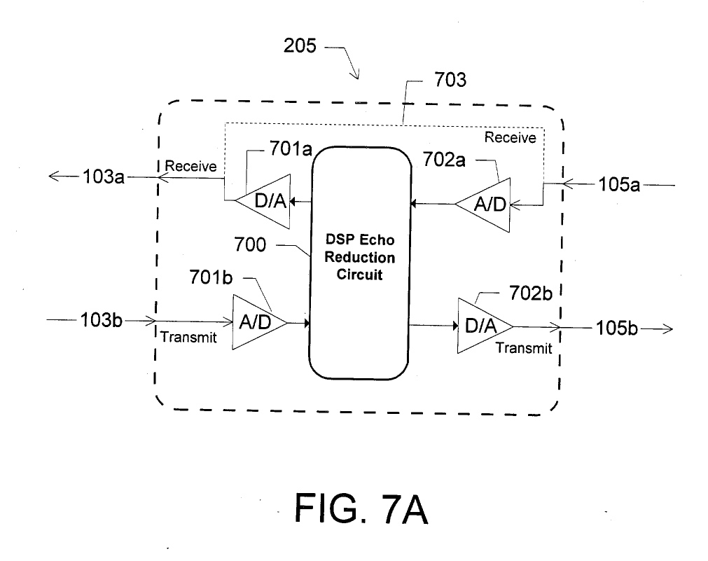

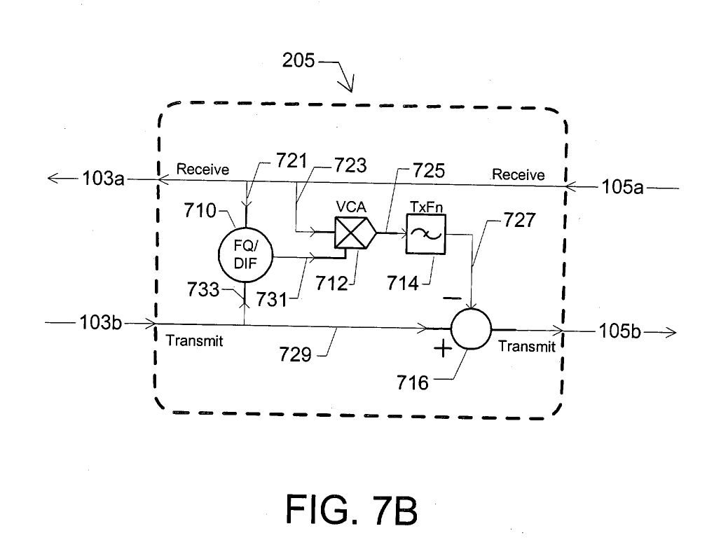

Referring now to FIG. 7A, one example of echo control circuit 205 is illustrated in a block diagram of some of the electrical components. In one example of a receive path from audio source 106 (FIG. 1), echo control circuit 205 may include an analog-to-digital (A/D) converter 702a to receive an analog input audio signal along lead 105a from audio source 106 (FIG. 1). A/D converter 702a converts the signal into a digital signal for processing by digital signal processor (DSP) 700. A/D converter 702a may be any suitable means for decoding and digitizing analog audio signals.

As further shown in FIG. 7A, the digital signal from DSP 700 may be sent to a digital-to-analog (D/A) converter 701a for conversion of the digital signal to an analog signal. D/A converter 701a may be any suitable device for converting digital audio signals to analog audio signals. Finally, the analog signal is sent along lead 103a to headset or handset device 202 (FIG. 2), where it is converted into an acoustic signal which is heard by the user.

Alternatively, since the incoming receive signal needs only to be monitored or sampled by the processor, A/D converter 702a can monitor the receive signal along lead 105a, and lead 703 (shown by dashed lines) could be used to bypass any conversion and signal processing on the receive signal. Thus, D/A converter 701a could be omitted in this example.

Similarly, in another embodiment, headset or handset device 202 (FIG. 2) may receive digital signals. After DSP 700 samples the digitized input signal, or the digital signal is directly sent to headset or handset device 202 (FIG. 2), the digital signal may be converted into an acoustic signal by headset or handset device 202 (FIG. 2) which is heard by the user. Again, D/A converter 701a may be omitted in this embodiment.

In an example of a transmit path from headset or handset device 202 (FIG. 2), echo control circuit 205 may include an analog-to-digital (A/D) converter 701b to receive an analog audio signal along lead 103b from headset or handset device 202 (FIG. 2). A/D converter 701b may be any suitable means for decoding and digitizing analog audio signals. A/D converter 701b converts the signal into a digital signal for delivery to the digital input of DSP 700.

DSP 700 separates the transmit signal (including undesirable signal leakage from insufficient isolation between the earphone and microphone and delay from the packet-switched network) into elements that can be compared with the monitored receive signal delivered to DSP 700 from A/D converter 702a. If measured amounts of receive signal are detected in the transmit signal, then a DSP algorithm will create a correction signal (anti-signal) to remove the detected receive signal from the transmit signal.

Transfer functions, either specific to audio input/output device 102 (FIG. 1) or more generally applicable, may be used to provide frequency and level adjustments to represent the leakage path characteristics of the audio input/output device 102 (FIG. 1). In one example, transfer functions may be determined using laboratory telephone headsets or handsets to monitor signal leakage over frequency and gain.

It is noted that various techniques have been proposed and implemented with telephones and speakerphones in order to address the problem of echoes due to acoustic coupling. These techniques generally fall into categories of echo suppression and echo cancellation. Echo cancellation typically involves calculating an estimated echo signal from the speaker output signal and subtracting the estimated echo signal from the microphone transmit signal, thus generating a corrected transmit signal. Echo suppression, on the other hand, typically involves operating the telephone in half-duplex mode wherein only one path (the receive path or the transmit path) is open at any one time. It is also known to operate the telephone in a quasi-half duplex mode in which neither path is fully closed, but one path may be attenuated more than the other path at any give time. Various forms of DSP echo cancellation and/or suppression algorithms may be used in accordance with the present invention, as will be evident to those of ordinary skill in the art.

Referring again to FIG. 7A, the adjusted digital signal from DSP 700 is then sent to digital-to-analog (D/A) converter 702b for conversion of the digital signal to an analog signal. D/A converter 702b may be any suitable device for converting digital audio signals to analog audio signals. It is noted that A/D converter 702a and D/A converter 702b need not be separate devices but may be combined into a single structure. Similarly, it is noted that D/A converter 701a and A/D converter 701b need not be separate devices but may be combined into a single structure. Finally, the analog signal is sent along lead 105b to audio source 106 (FIG. 1) with reduced echo. Advantageously, such a method encompassed in echo control circuit 205 described above allows for adaptive echo cancellation or control as the leakage path may constantly be changing depending upon acoustic, electromechanical, and/or network properties.

FIG. 7B illustrates another example of echo control circuit 205 that may be used in accordance with the present invention to reduce or eliminate echo while communicating through a headset or handset apparatus. In this example, echo control circuit 205 includes analog signal processing blocks. Advantageously, this example does not require conversion to the digital domain and thereby eliminates the additional signal delays caused by analog and digital conversions and by the processing latency associated with the DSP. However, this example is not as easily adaptable or programmable in reducing echo as the previously described example illustrated in FIG. 7A.

Referring again to FIG. 7B, a signal is received from audio source 106 (FIG. 1) along lead 105a and sent to headset or handset device 202 (FIG. 2) along lead 103a. A frequency difference amplifier 710 receives the receive signal along lead 721 and the transmit signal from headset or handset device 202 (FIG. 2) along lead 733. Frequency difference amplifier 710 provides a comparison of the receive and transmit signals. If the transmit signal matches some of the receive signal, frequency difference amplifier 710 provides a control signal along lead 731 to enable a voltage controlled amplifier (VCA) 712. VCA 712 produces a limited amount of receive signal along lead 725 to be used as a correction signal.

The limited amount of receive signal from VCA 712 is modified by a transfer function 714 either specific to headset or handset device 202 (FIG. 2) or more generally applicable to a group of headset or handset devices. Transfer function 714 provides frequency and level adjustments to best represent the leakage path characteristics of headset or handset device 202 (FIG. 2) and may be applied by software or hardware. Optionally, table readouts of the transfer function between electrical signal received by the earphone and leakage signal transmitted through the microphone for the range of adaptable headsets or handsets may be used to modify the correction signal. In one example, transfer function 714 may be determined using laboratory telephone headsets or handsets to monitor signal leakage over frequency and gain.

The resulting correction signal is sent along lead 727 to a sum/difference amplifier 716 where the correction signal is subtracted from the transmit signal sent to sum/difference amplifier 716 along lead 729. The resulting output of sum/difference amplifier 716 is sent along lead 105b to audio source 106 (FIG. 1) as an echo-reduced transmit signal from headset or handset device 202 (FIG. 2). It is again noted that various forms of analog design and signal processing may be used, as will be evident to those of ordinary skill in the art. Furthermore, it is noted that if the human interface to audio input/output device 102 (FIG. 1) dramatically changes the transfer function of audio input/output device 102 (FIG. 1) in real-time, then the lack of analog adaptability may limit the available range of echo control in this example.

It is noted that the above described echo control circuits are simply examples of various echo control circuitry that may be used in accordance with the present invention and is not meant to limit the scope of echo control circuit 205. For example, echo control circuit 205 may even be modified to include voice switching functionality to reduce background noise and provide for enhanced sound quality. In such an example, echo control circuit 205 may operate to lower the transmit gain of the near end user's headset (e.g., by approximately 12 dB) when not in use or when transmission signals are not detected above a certain level to thereby reduce and/or eliminate echo to the far end user. It is further noted that the above described echo control circuits are examples of echo control circuitry that may be included in the other echo control circuits and printed circuit boards described above.

The above-described embodiments of the present invention are merely meant to be illustrative and not limiting. It will thus be obvious to those skilled in the art that various changes and modifications may be made without departing from this invention in its broader aspects. For example, while communication channels within FIGS. 1-7B have been referred to as leads, it should be understood that what are called leads can be buses capable of carrying a plurality of signals (either digital or analog as appropriate) in parallel or can even be wireless communication channels. Therefore, the appended claims encompass all such changes and modifications as falling within the true spirit and scope of this invention.

1. An echo control retrofit apparatus, comprising:
a first connector half disposed at an end of a first cable, the first connector half including a housing having a mating end and an oppositely disposed cable receiving end, and an echo control circuit on a printed circuit board operably coupled to the first cable within the housing; and
a second connector half disposed at an end of a second cable, the second connector half including a housing having a mating end and an oppositely disposed cable receiving end,
wherein the mating ends of the first connector half and the second connector half are capable of being coupled together for operably coupling the second cable to the echo control circuit of the first connector half, and
wherein the echo control circuit is capable of receiving a sound signal from an audio source along the first or second cable, comparing the sound signal along the first or second cable to a transmission sound signal from an audio input/output device received along the other of the first or second cable, and providing an adjusted transmission sound signal to control for echo.

2. The apparatus of claim 1, wherein an end of the first cable is directly connected to a headset or handset device that is external to the echo control retrofit apparatus, and an end of the second cable is coupled to an audio source that is external to the echo control retrofit apparatus.

3. The apparatus of claim 1, wherein an end of the first cable is coupled to an audio source that is external to the echo control retrofit apparatus, and an end of the second cable is directly connected to a headset or handset device that is external to the echo control retrofit apparatus.

4. The apparatus of claim 1, wherein the echo control circuit is capable of receiving a sound signal from an audio source selected from the group consisting of a communications network, a computer, a telephone, and a cellular telephone.

5. The apparatus of claim 1, wherein the echo control circuit is capable of receiving a sound signal from an audio source, comparing the sound signal from the audio source to a transmission sound signal from an audio input/output device, and providing an adjusted transmission sound signal to the audio source.

6. The apparatus of claim 5, wherein the sound signal from the audio source is delayed through a packet-switched network prior to being received by the echo control circuit.

7. The apparatus of claim 1, wherein the echo control circuit comprises a digital signal processor.

8. The apparatus of claim 1, wherein the echo control circuit comprises a transfer function specific to a headset or handset device.

9. The apparatus of claim 1, wherein the echo control circuit includes a gain control circuit for voice switching.

10. The apparatus of claim 1, further comprising a coupler disposed at an end of the first cable opposite the first connector half or at an end of the second cable opposite the second connector half.

11. The apparatus of claim 10, wherein the coupler is selected from the group consisting of an amplifier, a RJ-11 connector, and a 2.5 mm or 3.5 mm plug.

12. The apparatus of claim 10, wherein the coupler is coupled to a headset or handset device.

13. The apparatus of claim 10, wherein the coupler is coupled to an audio source selected from the group consisting of a communications network, a computer, a telephone, and a cellular telephone.

14. An echo control retrofit apparatus, comprising:
a housing enclosing an echo control circuit on a printed circuit board;
a first mating end coupled to one end of the housing and operably coupled to the echo control circuit;
a second mating end coupled to another end of the housing and operably coupled to the echo control circuit,
wherein the echo control circuit is capable of receiving a sound signal from an audio source through the first or the second mating end, comparing the sound signal received through the first or the second mating end to a transmission sound signal from an audio input/output device received through the other of the first or second mating end, and providing an adjusted transmission sound signal to control for echo.

15. The apparatus of claim 14, wherein the first mating end is operably coupled to a headset or handset device that is external to the echo control retrofit apparatus, and the second mating end is operably coupled to an audio source that is external to the echo control retrofit apparatus.

16. The apparatus of claim 14, wherein the second mating end is operably coupled to a headset or handset device that is external to the echo control retrofit apparatus, and the first mating end is operably coupled to an audio source that is external to the echo control retrofit apparatus.

17. The apparatus of claim 14, wherein the echo control circuit is capable of receiving a sound signal from an audio source selected from the group consisting of a communications network, a computer, a telephone, and a cellular telephone.

18. The apparatus of claim 14, wherein the echo control circuit is capable of receiving a sound signal from an audio source, comparing the sound signal from the audio source to a transmission sound signal from an audio input/output device, and providing an adjusted transmission sound signal to the audio source.

19. The apparatus of claim 18, wherein the sound signal from the audio source is delayed through a packet-switched network prior to being received by the echo control circuit.

20. A method of retrofitting echo control, comprising:
providing an echo control retrofit apparatus capable of operably coupling a first cable and a second cable including:
a first connector half disposed at an end of the first cable, the first connector half including a housing having a mating end and an oppositely disposed cable receiving end, and an echo control circuit on a printed circuit board operably coupled to the first cable within the housing; and
a second connector half disposed at an end of the second cable, the second connector half including a housing having a mating end and an oppositely disposed cable receiving end, wherein the mating ends of the first connector half and the second connector half are capable of being coupled together for operably coupling the second cable to the echo control circuit of the first connector half;
operably coupling the mating ends of the first connector half and the second connector half;
providing a sound signal from an audio source to the echo control circuit along the first or second cable;
comparing the sound signal from the audio source to a transmission sound signal from a headset or handset device received along the other of ht e first or second cable;
adjusting the transmission sound signal from the headset or handset device as necessary to control for echo; and
providing the adjusted transmission sound signal to the audio source.

21. The method of claim 20, wherein the sound signal from the audio source is delayed through a packet-switched network prior to being received by the echo control circuit.
